(19) United States
(12) Patent Application Publication
(10) Pub. No.: US 2025/0347944 A1
(43) Pub. Date: Nov. 13, 2025

(54) ELECTRIC CONTROL GLASS DEVICE AND VEHICLE

(71) Applicant: HON HAI PRECISION INDUSTRY CO., LTD., New Taipei (TW)

(72) Inventor: YEN-SHOU HSIEH, New Taipei (TW)

(21) Appl. No.: 18/898,986

(22) Filed: Sep. 27, 2024

(30) Foreign Application Priority Data
May 8, 2024 (CN) 202410561607.0

(51) Int. Cl. G02F 1/133; B60J 3/04; G02F 1/1333; G02F 1/137

(52) U.S. Cl. CPC G02F 1/13324; B60J 3/04; G02F 1/133365; G02F 1/137

(57) ABSTRACT

An electric control glass device includes a reverse electric control glass assembly and a controller. The reverse electric control glass assembly includes reverse electric control glass. The reverse electric control glass maintains in a non-transparent state when receiving electrical signals, and maintains in a transparent state when receiving no electrical signal. The controller is electrically connected to the reverse electric control glass and configured for controlling the reverse electric control glass to be in a power on state or a power off state. When the controller controls the reverse electric control glass to be the power on state, the reverse electric control glass receives the electrical signals to maintain in the non-transparent state. When the controller controls the reverse electric control glass to be the power off state, the reverse electric control glass receives no electrical signal to maintain transparent.

### FIELD

The subject matter herein relates to a field of automotive glass technology, particularly relates to an electric control glass device and a vehicle having the electric control glass device.

### BACKGROUND

Dimming glass generally uses a polymer dispersed liquid crystal (PDLC) dimming film. The PDLC dimming layer changes haziness of the dimming glass according to changes in electrical signals. When the dimming glass suddenly loses power, the PDLC dimming film will keep the dimming glass in a non-transparent state, and the sunlight cannot fully pass through the dimming glass, affecting users to observe environmental changes through the dimming glass and ultimately causing major safety concerns. Photochromic or thermochromic material may also be used as dimming layers. The photochromic material changes its own transmittance according to changes in ambient light. The thermochromic material changes its own transmittance according to changes in temperature. Due to characteristics of photochromic and thermochromic materials that adjust the transmittance according to external changes, when using photochromic or thermochromic materials as the dimming layer of the dimming glass, the dimming function of the dimming glass cannot be turned on or off according to usage scenario.

Therefore, there is room for improvement in the art.

### BRIEF DESCRIPTION OF THE DRAWINGS

Implementations of the present technology will now be described, by way of embodiments only, with reference to the attached figures.

FIG. 1 is a schematic view of an electric control glass device according to a first embodiment of the present disclosure.

FIG. 2 is a cross-sectional view of a reverse electric control glass assembly in FIG. 1.

FIG. 3 is a view showing working modes of the electric control glass device in FIG. 1.

FIG. 4 is a schematic view of an electric control glass device according to a second embodiment of the present disclosure.

FIG. 5 is a schematic view of a first combination form of a solar energy conversion device and the reverse electric control glass in the second embodiment of the present disclosure.

FIG. 6 is a schematic view of a second combination form of a solar energy conversion device and the reverse electric control glass in the second embodiment of the present disclosure.

FIG. 7 is a schematic view of a third combination form of a solar energy conversion device and the reverse electric control glass in the second embodiment of the present disclosure.

FIG. 8 is a schematic view of a partial of a vehicle according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

### First Embodiment

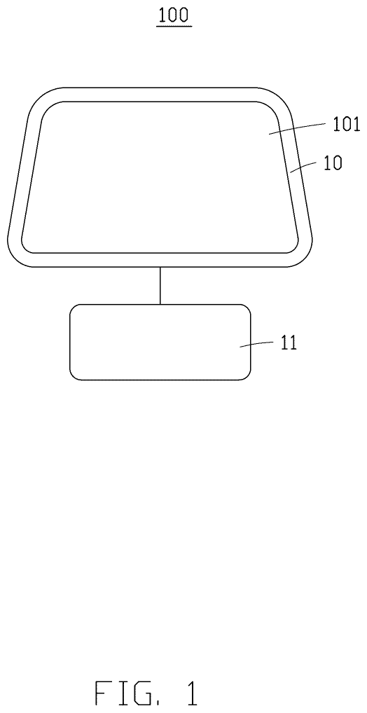

FIG. 1 illustrates an electric control glass device 100. The electric control glass device 100 includes a reverse electric control glass assembly 10 and a controller 11. The reverse electric control glass assembly 10 includes a reverse electric control glass 101. The controller 11 is electrically connected to the reverse electric control glass assembly 10 for controlling the reverse electric control glass assembly 10 to be in a power on state or a power off state and changing a haziness of the reverse electric control glass 101.

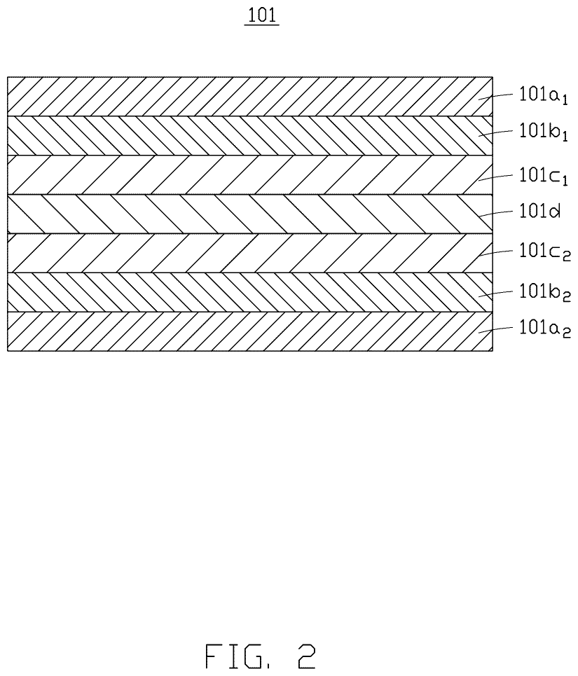

As shown in FIG. 2, the reverse electric control glass 101 in this embodiment includes a first glass layer 101a₁, a first adhesive layer 101b₁, a first conductive layer 101c₁, a dimming layer 101d, a second conductive layer 101c₂, a second adhesive layer 101b₂, and a second glass layer 101a₂ that are sequentially stacked. In other embodiments, the reverse electric control glass 101 has other structures. For example, the reverse electric control glass 101 includes multiple dimming layers 101d, multiple first conductive layers 101c₁, and multiple second conductive layers 101c₂.

The first glass layer 101ₐ₁, the second glass layer 101ₐ₂, the first adhesive layer 101_{b1}, the second adhesive layer 101_{b2}, the first conductive layer 101_{c1}, and the second conductive layer 101_{c2} are all transparent materials. The first adhesive layer 101b1 is used to connect the first glass layer 101a₁ and the first conductive layer 101c₁. The second adhesive layer 101c₂ is used to connect the second glass layer 101a₂ and the second conductive layer 101c₂. Both the first conductive layer 101c₁ and the second conductive layer 101c₂ are electrically connected to the controller 11 for receiving electrical signals from the controller 11 and transmitting the received electrical signals to the dimming layer 101d. The dimming layer 101d is electrically connected to both the first conductive layer 101c₁ and the second conductive layer 101c₂.

The dimming layer 101d is a film layer containing liquid crystal molecules, especially can be a polymer network liquid crystal (PNLC) dimming film. The liquid crystal material used to make PNLC dimming film can be cholesteric liquid crystals, dual frequency liquid crystals, near crystalline A-phase liquid crystals, ferroelectric liquid crystals, etc. When the dimming layer 101d receives electrical signal, the liquid crystal molecules in the dimming layer 101d are irregularly dispersed, causing the haziness of the dimming layer 101d to change with strength of the electrical signal. When the dimming layer 101d does not receive any electrical signal, that is, when the reverse electric control glass 101 is powered off, the liquid crystal molecules in the dimming layer 101d are arranged neatly and regularly, making the dimming layer 101d to be transparent.

A user can choose to operate the reverse electric control glass assembly 10 in either a first working mode or a second working mode.

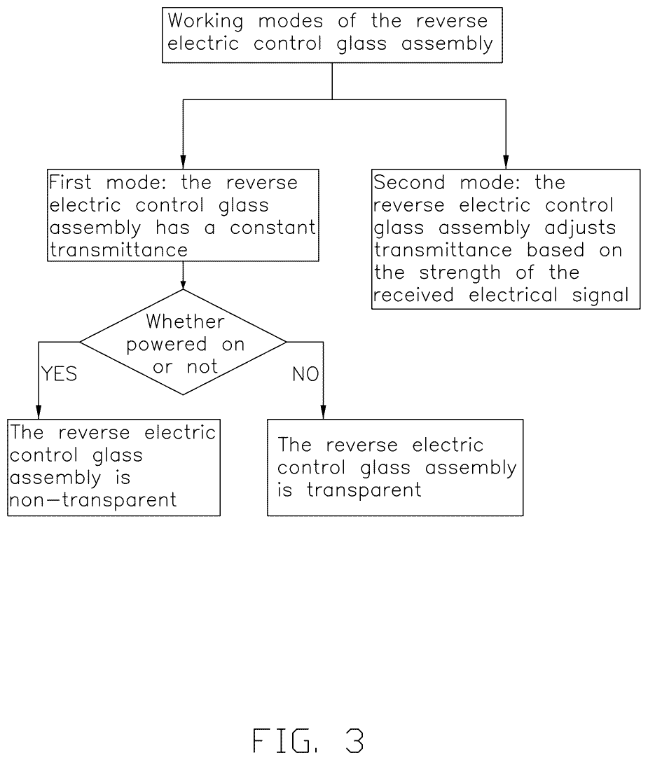

As shown in FIG. 3, when the reverse electric control glass assembly 10 is in the first working mode, the controller 11 can control the reverse electric control glass 101 to be in a power on state or a power off state. The reverse electric control glass 101 has different haziness (transmittance) when in the power on state or the power off state. When the reverse electric control glass 101 is in the power on state, it receives electrical signals, maintains in a non-transparent state and an unchanged haziness, thereby blocking a portion of the infrared and ultraviolet of sunlight from passing through the reverse electric control glass 101. When the reverse electric control glass 101 is in the power off state, it does not receive any electrical signal and keeps transparent, allowing sunlight to pass through the reverse electric control glass assembly 10. The haziness of the reverse electric control glass 101 in the transparent state is less than the haziness of the reverse electric control glass 101 in the non-transparent state. That is, a transmittance of the reverse electric control glass 101 in the non-transparent state is less than that in a transparent state.

In this embodiment, the controller 11 controls the power on state of reverse electric control glass 101 based on the intensity of ambient light. When the intensity of ambient light exceeds a preset threshold, the controller 11 controls the reverse electric control glass 101 to be powered on. When the intensity of ambient light is less than the preset threshold, the controller 11 controls the reverse electric control glass 101 to be powered off. In other embodiments, the controller 11 can control the power on state of the reverse electric control glass 101 according to user's needs. That is, the user may manually control power on or power off state of the reverse electric control glass 101 by the controller 11. Moreover, users can set the haziness of the reverse electric control glass 101 when it is in the power on state, so that the haziness of the reverse electric control glass 101 can meet the user's needs when it is in the power on state.

When the reverse electric control glass assembly 10 is in the second working mode, the controller 11 is also used to control a strength of the electrical signal provided to the reverse electric control glass 101. When the reverse electric control glass 101 is in a power on state, the reverse electric control glass 101 also adjusts the haziness based on the strength of the received electrical signal. The haziness of the reverse electric control glass 101 increases as the strength of the electrical signal. In this embodiment, an electrical signal is provided to the reverse electric control glass 101 by an external power supply, which can be a power generation device of a vehicle using the electric control glass device 100 or a portable mobile power supply.

In this embodiment, the controller 11 may include an optical sensor (not shown) for sensing intensity of ambient light, and the controller 11 may output electrical signals of different intensities to the reverse electric control glass 101 based on the intensity of ambient light. The strength of the electrical signal received by the reverse electric control glass 101 increases as the intensity of ambient light increases, thereby increasing the haziness of the reverse electric control glass 101 with the strength of the electrical signal, ultimately achieving dimming. In this disclosure, increase in haziness of the reverse electric control glass 101 refers to an enhanced blocking ability of the reverse electric control glass 101 against ambient light, that is, a decrease in transparency of the reverse electric control glass 101 against ambient light.

In this embodiment, the electric control glass device 100 includes a reverse electric control glass 101. When the reverse electric control glass 101 is in a power on state, the reverse electric control glass 101 atomizes. When the reverse electric control glass 101 is in a power off state, the reverse electric control glass 101 is transparent, that is, the haziness of the reverse electric control glass 101 is basically zero. Therefore, when the electric control glass device 100 unexpectedly loses power, the reverse electric control glass 101 is transparent and will not affect the user's observation of changes in the external environment, reducing a risk of safety accidents. When the user uses the electric control glass device 100, if the reverse electric control glass assembly 10 is in the first working mode, the haziness of the reverse electric control glass 101 does not change with the change of ambient light intensity. By the controller 11 to control the power on state of the reverse electric control glass 101, the reverse electric control glass 101 can switch between the non-transparent state and the transparent state based on whether it is powered on or not. If the reverse electric control glass assembly 10 is in the second working mode, the haziness of the reverse electric control glass 101 increases with the increase intensity of ambient light.

### Second Embodiment

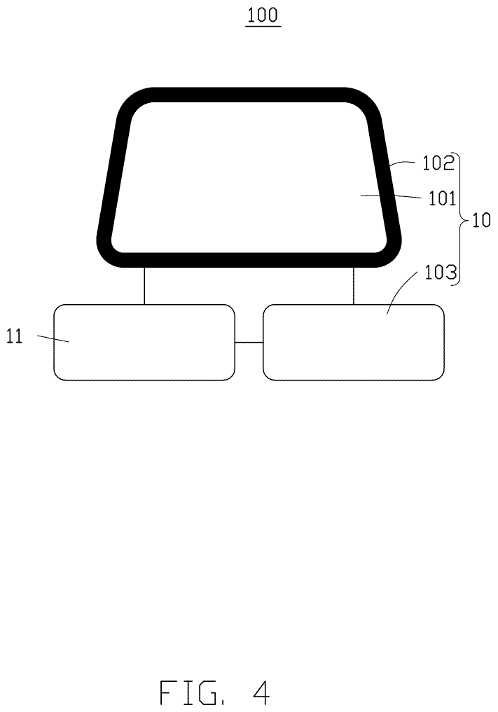

As shown in FIG. 4, an electric control glass device 100 not only includes a reverse electric control glass 101 and a controller 11, but also includes a solar energy conversion device 102 and a power supply battery 103. The power supply battery 103 is electrically connected to both the controller 11 and the solar energy conversion device 102, respectively. The solar energy conversion device 102 is used to convert solar energy into electrical energy, and the power supply battery 103 is used to store electrical energy for supplying power to the reverse electric control glass 101.

The electric control glass device 100 of this embodiment can also operate in a first working mode and a second working mode. The difference between the first embodiment and this embodiment is that the solar energy conversion device 102 and the power supply battery 103 provide electrical signals to the reverse electric control glass 101. In this embodiment, the controller 11 controls the power on state of the reverse electric control glass 101 based on the intensity of ambient light, or can control the power on state of the reverse electric control glass 101 based on the power generation intensity of the solar energy conversion device 102. In the power on state, the controller 11 can also change the strength of the electrical signal received by the reverse electric control glass 101 based on the power generation intensity of the solar energy conversion device 102. The controller 11 can also control the strength of the electrical signal provided by the power supply battery 103 to the reverse electric control glass 101, so that the strength of the electrical signal received by the reverse electric control glass 101 increases with the increase of the power generation intensity of the solar energy conversion device 102 when it is in the power on state. The power generation intensity of the solar energy conversion device 102 can be, for example, a magnitude of power generation efficiency. In a modified embodiment, the controller 11 may also include an optical sensor for sensing the intensity of ambient light. The controller 11 may output electrical signals of different strengths to the reverse electric control glass 101 based on the intensity of ambient light.

The solar energy conversion device 102 is a photovoltaic material that utilizes the photovoltaic effect. When light is irradiated on the solar energy conversion device 102 and received by the solar energy conversion device 102, a charge distribution state in the solar energy conversion device 102 changes, resulting in a potential difference. This enables conversion of solar energy into electrical energy and storage of the generated electrical energy in the power supply battery 103. The power supply battery 103 can be a lead-acid battery, a lithium-ion battery, or a sodium ion battery, etc.

The reverse electric control glass 101 and the solar energy conversion device 102 in the electric control glass device 100 have multiple combination modes. Following are three types of combination modes as examples for explanation, but not limited to the following three types of combination modes.

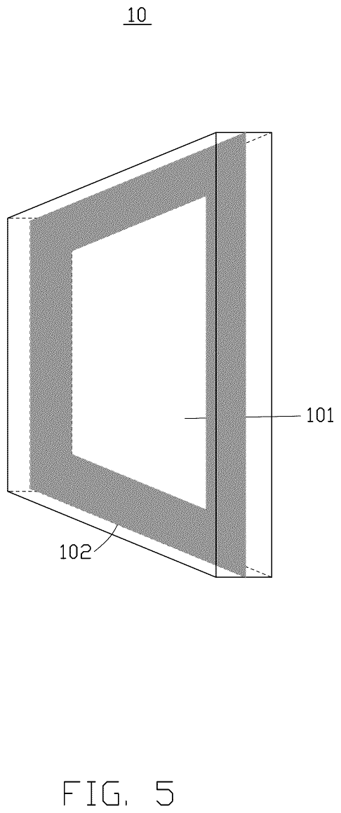

First mode: as shown FIG. 5, the reverse electric control glass 101 is a flat plate having a rectangular contour, and the solar energy conversion device 102 is a solar energy glass and defines a rectangular opening. The reverse electric control glass 101 is in the rectangular opening. The solar energy conversion device 102 surrounds and connected to the reverse electric control glass 101. In other embodiments, the reverse electric control glass 101 and the solar energy conversion device 102 have other shapes, for example, the reverse electric control glass 101 is trapezoidal, and the solar energy conversion device 102 is a frame structure with a trapezoidal opening.

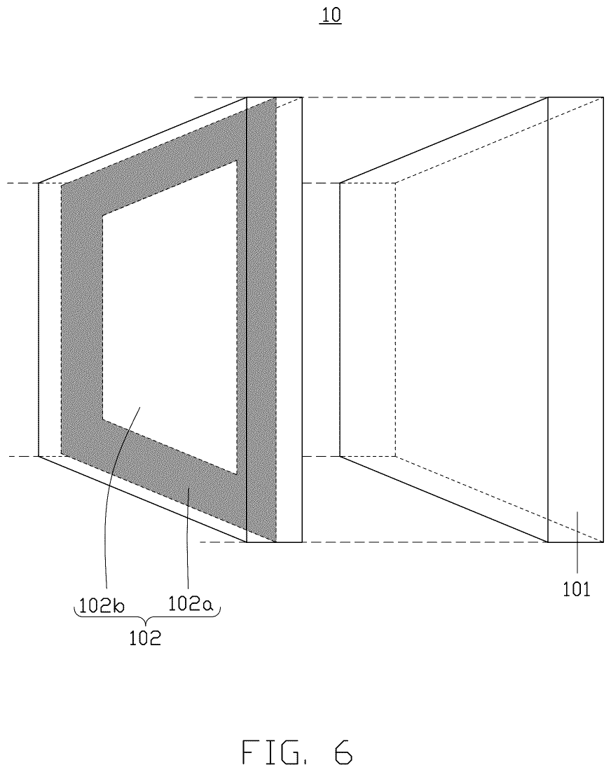

Second mode: as shown FIG. 6, the solar energy conversion device 102 is a solar glass, and both the solar energy conversion device 102 and the reverse electric control glass 101 are rectangular and have a same length and a same width. The solar energy conversion device 102 and the reverse electric control glass 101 are stacked with flush edges. The solar energy conversion device 102 includes a power generation area 102a and a non-power generation area 102b. The power generation area 102a surrounds the non-power generation area 102b that is rectangular. In other embodiments, the reverse electric control glass 101 and the solar energy conversion device 102 have other shapes. For example, both the reverse electric control glass 101 and the solar energy conversion device 102 are trapezoidal, the power generation area 102a is a frame structure defining a trapezoidal opening, and the non-power generation area 102b is a flat plate structure having a trapezoidal contour. The power generation area 102a is used to convert solar energy into electrical energy, while the non-power generation area 102b is transparent and used to allow ambient light to pass through. When the reverse electric control glass assembly 10 is connected to a vehicle, the reverse electric control glass 101 is located on a side close to the vehicle, and the solar energy conversion device 102 is located on a side of the reverse electric control glass 101 far away from the vehicle, so the solar energy glass 102 can directly receive sunlight. In this case, the reverse electric control glass 101 includes a fogging area and a transparent area surrounding the fogging area. The fogging area keeps fogged when the reverse electric control glass 101 is powered on, and the transparent area is transparent. The fogging area corresponds to and aligns with the non-power generation area.

In other embodiments, the solar energy conversion device 102 is located on a side close to the vehicle, and the reverse electric control glass 101 is located on a side of the solar energy conversion device 102 far away from the vehicle. In this case, it is not required that the reverse electric control glass 101 has a transparent area.

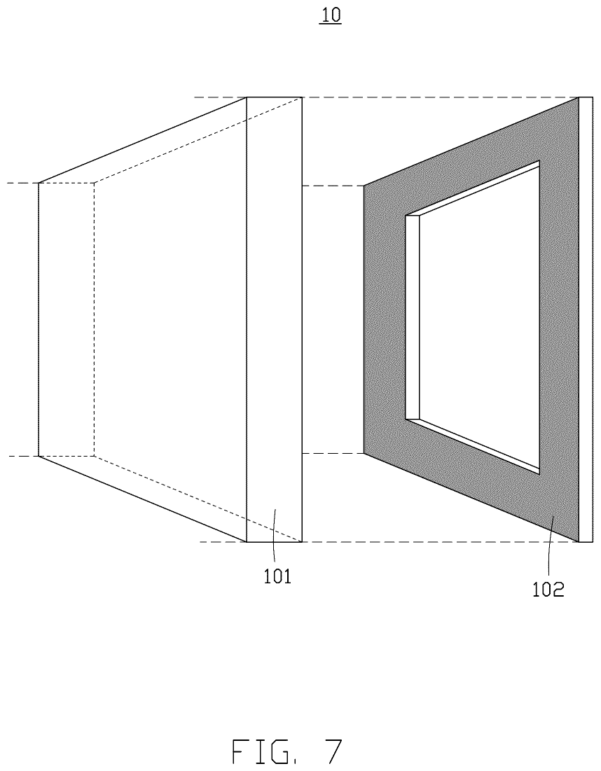

Third mode: the solar energy conversion device 102 is a solar coating made of thin film solar material. As shown in FIG. 7, the reverse electric control glass 101 is rectangular, and the solar energy conversion device 102 is coated along two long sides and two short sides of the reverse electric control glass 101, completely covering the edges of the reverse electric control glass 101. A center part of the reverse electric control glass 101 is not covered by the solar energy conversion device 102.

In other embodiments, the reverse electric control glass 101 has other shapes, for example, the reverse electric control glass 101 is trapezoidal. When the reverse electric control glass assembly 10 is connected to a vehicle, the solar energy conversion device 102 is located on a side of the reverse electric control glass 101 away from the vehicle and configured for directly receiving sunlight, and a protective film is coated on a surface of the solar energy conversion device 102 away from the reverse electric control glass 101. Alternatively, the solar energy conversion device 102 is located on a side of the reverse electric control glass 101 facing the vehicle, isolating the solar energy conversion device 102 from outside of the vehicle, thereby preventing damage to the solar energy conversion device 102.

In this embodiment, the electric control glass device 100 further includes a solar energy conversion device 102 and a power supply battery 103. The solar energy conversion device 102 uses solar energy as the power source for the reverse electric control glass assembly 10. Due to the fact that solar energy is a clean energy source, the use of solar energy as a power source in the electric control glass device 100 can play a role in protecting the environment.

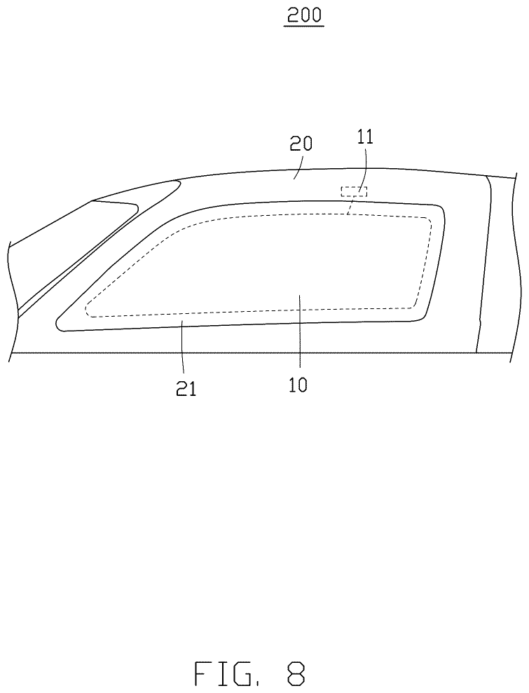

As shown in FIG. 8, a vehicle 200 of the present embodiment includes a vehicle body 20 and at least one electric control glass device 100 according to any one of the first and second embodiments. The controller 11 of the electric control glass device 100 is mounted in the vehicle body 20. At least one installation position is provided on the vehicle body 20, and the reverse electric control glass assembly 10 of the electric control glass device 100 is set in the above installation position. When the vehicle body 20 includes multiple electric control glass devices 100, multiple installation positions are provided on the vehicle body 20, which correspond one-to-one with the multiple electric control glass devices 100. The reverse electric control glass assembly 10 of each electric control glass device 100 is correspondingly set in one installation position. The above installation position can be installed on a front windshield position, a rear windshield position, a window position, a rearview mirror position, and other position of the vehicle body 200, so that the reverse electric control glass assembly 10 serves as the front windshield, the rear windshield, the windows, the rearview mirror of the vehicle 200.

In at least one embodiment, the reverse electric control glass assembly 10 serves as the window of the vehicle body 20. The vehicle 200 also includes a glass material coating 21, which is located between the vehicle body 20 and the reverse electric control glass assembly 10. The glass material coating 21 is used to roughen edges of the reverse electric control glass assembly 10, facilitate subsequent applying adhesive, and thereby connect the vehicle body 20 and the reverse electric control glass assembly 10. The controller 11 of the electric control glass device 100 is electrically connected to the reverse electric control glass 101. The controller 11 is used to change the power state of the reverse electric control glass 101 and cause the reverse electric control glass 101 to change its own haziness based on changes in the strength of the electrical signal.

When using the electric control glass device 100, users can put the reverse electric control glass assembly 10 in different working modes. When the reverse electric control glass assembly 10 is in the first working mode and the reverse electric control glass 101 is in the power on state, the reverse electric control glass 101 receives the electrical signals that keeps non-transparent and the haziness remains unchanged. The ultraviolet and infrared parts of the sunlight are blocked outside the vehicle, and the temperature inside the vehicle will not rise.

When the reverse electric control glass assembly 10 is in the first working mode and the reverse electric control glass 101 is in a power off state, the reverse electric control glass 101 does not receive electrical signals and keeps transparent. Users can observe external environment and will not have an impact on driving the vehicle.

When the reverse electric control glass assembly 10 is in the second working mode, the reverse electric control glass 101 is in a power on state. The controller 11 increases the strength of the electrical signal received by the reverse electric control glass 101 with increase of the power generation intensity of the solar energy conversion device 102, thereby increasing the haziness of the reverse electric control glass 101 with the increase of the electrical signal intensity, improving the user's use effect.

The electric control glass device 100 has the following beneficial effects: when using the electric control glass device 100, the user can manually change a working mode of the reverse electric control glass assembly 10. When the reverse electric control glass assembly 10 is in the first working mode, the controller 11 controls the reverse electric control glass 101 to switch between the power on state or the power off state. When the reverse electric control glass 101 is in the power on state, the reverse electric control glass 101 is in the non-transparent state and the haziness keeps unchanged, and the infrared and ultraviolet parts in the sunlight cannot pass through the reverse electric control glass assembly 10. When the reverse electric control glass 101 is in a power off state, the reverse electric control glass 101 is transparent, and sunlight passes through the reverse electric control glass assembly 10. The haziness of reverse electric control glass 101 when it is in a transparent state is less than that when it is in a non-transparent state. When the reverse electric control glass assembly 10 is in the second working mode, the controller 11 causes the strength of the electrical signal received by the reverse electric control glass 101 to change, thereby causing the haziness of reverse electric control glass 101 to change with the strength of the electrical signal. When the reverse electric control glass assembly 10 is in the first working mode, the reverse electric control glass 101 switches between the non-transparent state and the transparent state based on whether it is powered on or not. When the reverse electric control glass assembly 10 is in the second working mode, the haziness of the reverse electric control glass 101 increases as the power generation intensity of the solar energy conversion device 102 increases, and the power generation intensity of the solar energy conversion device 102 increases as the ambient light intensity increases. That is, the haziness of the reverse electric control glass 101 increases as the ambient light intensity increases, ultimately achieving the dimming function.

Compared to conventional technology, a dimming part of the electric control glass device 100 in the present embodiment is a reverse electric control glass assembly 10. When the reverse electric control glass assembly 10 is in a power on state, the reverse electric control glass 101 atomizes. When the reverse electric control glass 101 is in a power off state, the reverse electric control glass 101 is transparent. Therefore, when the electric control glass device 100 unexpectedly loses power, the reverse electric control glass 101 will not affect the user's observation of environmental through the reverse electric control glass assembly 10, reducing a risk of safety accidents. The electric control glass device 100 includes a solar energy conversion device 102, which is used to convert the solar energy in ambient light into electrical energy to supply power to the reverse electric control glass assembly 10. That is, the electric control glass device 100 can use the solar energy in ambient light as the power source. The ambient light can be sunlight, and since the solar energy in sunlight is a clean energy source, the electric control glass device 100 can use the solar energy in sunlight as a power source to protect the environment. The electric control glass device 100 also includes a controller 11. The user selects the reverse electric control glass assembly 10 to be in different working modes, and the controller 11 controls the reverse electric control glass 101 to be in different energized states, thereby powering on or off the dimming function of the reverse electric control glass assembly 10.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An electric control glass device comprising:
a reverse electric control glass assembly comprising reverse electric control glass, the reverse electric control glass maintaining in a non-transparent state when receiving electrical signals, and maintaining in a transparent state when receiving no electrical signal; and
a controller electrically connected to the reverse electric control glass and configured for controlling the reverse electric control glass to be in a power on state or in a power off state,
wherein when the controller controls the reverse electric control glass to be in the power on state, the reverse electric control glass receives the electrical signals to maintain in the non-transparent state; when the controller controls the reverse electric control glass to be in the power off state, the reverse electric control glass receives no electrical signal to maintain in the transparent state.

2. The electric control glass device of claim 1, wherein when the reverse electric control glass is in the power on state, the reverse electric control glass is configured for adjusting degrees of haziness of the reverse electric control glass based on a strength of the electrical signal received by the reverse electric control glass.

3. The electric control glass device of claim 2, wherein when the reverse electric control glass is in the power on state, the controller is further configured to control the strength of the electrical signal provided to the reverse electric control glass, and a haziness of the reverse electric control glass increases as the strength of the electrical signal increases.

4. The electric control glass device of claim 1, further comprising a power supply battery and a solar energy conversion device, wherein the power supply battery is electrically connected to the controller and the solar energy conversion device;
the solar energy conversion device converts solar energy into electrical energy, and the power supply battery stores the electrical energy to provide the electrical signal for the reverse electric control glass.

5. The electric control glass device of claim 4, wherein the controller is further configured to control the strength of the electrical signal received by the reverse electric control glass based on a power generation intensity of the solar energy conversion device, such that the strength of the electrical signal received by the reverse electric control glass increases as the power generation intensity of the solar energy conversion device increases.

6. The electric control glass device of claim 4, wherein the solar energy conversion device is a solar glass; the solar glass surrounds and is connected to the reverse electric control glass, and the solar glass is integrated with the reverse electric control glass.

7. The electric control glass device of claim 4, wherein the solar energy conversion device is a solar glass, the solar glass is stacked with the reverse electric control glass; the solar glass comprises a power generation area and a non-power generation area, the power generation area surrounds and connects to the non-power generation area, the power generation area is configured to convert the solar energy into electrical energy, and the non-power generation area is transparent.

8. The electric control glass device of claim 4, wherein the solar energy conversion device is a solar energy coating, the solar energy coating is coated on an edge portion of a surface of the reverse electric control glass.

9. A vehicle comprising:
a vehicle body; and
an electric control glass device mounted on the vehicle body, the electric control glass device comprising:
a reverse electric control glass assembly comprising reverse electric control glass, the reverse electric control glass maintaining in a non-transparent state when receiving electrical signals, and maintaining in a transparent state when receiving no electrical signal; and
a controller electrically connected to the reverse electric control glass and configured for controlling the reverse electric control glass to be in a power on state or in a power off state,
wherein when the controller controls the reverse electric control glass to be in the power on state, the reverse electric control glass receives the electrical signals to maintain in the non-transparent state; when the controller controls the reverse electric control glass to be in the power off state, the reverse electric control glass receives no electrical signal to maintain in the transparent state.

10. The vehicle of claim 9, further comprising a glass material coating, wherein the glass material coating is located between the vehicle body and the reverse electric control glass assembly; the glass material coating is used to connect the vehicle body and the reverse electric control glass assembly.

11. The vehicle of claim 9, wherein when the reverse electric control glass is in the power on state, the reverse electric control glass is configured for adjusting degrees of haziness of the reverse electric control glass based on a strength of the electrical signal received by the reverse electric control glass.

12. The vehicle of claim 11, wherein when the reverse electric control glass is in the power on state, the controller is further configured to control the strength of the electrical signal provided to the reverse electric control glass, and a haziness of the reverse electric control glass increases as the strength of the electrical signal increases.

13. The vehicle of claim 9, further comprising a power supply battery and a solar energy conversion device, wherein the power supply battery is electrically connected to the controller and the solar energy conversion device;
the solar energy conversion device converts solar energy into electrical energy, and the power supply battery stores the electrical energy to provide the electrical signal for the reverse electric control glass.

14. The vehicle of claim 13, wherein the controller is further configured to control the strength of the electrical signal received by the reverse electric control glass based on a power generation intensity of the solar energy conversion device, such that the strength of the electrical signal received by the reverse electric control glass increases as of the power generation intensity of the solar energy conversion device increases.

15. The vehicle of claim 13, wherein the solar energy conversion device is a solar glass; the solar glass surrounds and is connected to the reverse electric control glass, and the solar glass is integrated with the reverse electric control glass.

16. The vehicle of claim 13, wherein the solar energy conversion device is a solar glass, the solar glass is stacked with the reverse electric control glass; the solar glass comprises a power generation area and a non-power generation area, the power generation area surrounds and connects to the non-power generation area, the power generation area is configured to convert the solar energy into electrical energy, and the non-power generation area is transparent.

17. The vehicle of claim 13, wherein the solar energy conversion device is a solar energy coating, the solar energy coating is coated on an edge portion of a surface of the reverse electric control glass.
